(19) United States
(12) Patent Application Publication
(10) Pub. No.: US 2016/0227300 A1
(43) Pub. Date: Aug. 4, 2016

(54) Systems And Methods For A Cross-Layer Optical Network Node

(71) Applicant: The Trustees of Columbia University in the City of New York, New York, NY (US)

(72) Inventors: Caroline P. LAI, Brossard (CA); Keren Bergman, Princeton, NJ (US)

(21) Appl. No.: 14/184,261

(22) Filed: Feb. 19, 2014

Related U.S. Application Data
(63) Continuation of application No. PCT/US2012/038301, filed on May 17, 2012.
(60) Provisional application No. 61/527,378, filed on Aug. 25, 2011.

(51) Int. Cl. H04Q 11/00; H04J 14/02; H04B 10/70; H04B 10/079

(52) U.S. Cl. CPC H04Q 11/0005; H04B 10/0795; H04J 14/0267; H04B 10/70; H04Q 11/0066; H04Q 2011/0016; H04Q 2011/0039; H04Q 2011/0015

(57) ABSTRACT

Optical network routes an optical message from at least one source to at least two destination ports of a plurality of destination ports. The optical network includes at least one input port to receive the optical message, two or more output ports, each configured to communicate with a corresponding destination port of the plurality of destination ports, and a plurality of photonic switching nodes configured to route the optical message from the at least one input port to the at least two destination ports. In another aspect, optical network includes a monitor to measure an attribute of the optical message, and a photonic switching node to route the optical message between a source and a destination port based on the attribute. In another aspect, optical network includes a sensor to sample an optical message, and a processor to derive at least one eye diagram corresponding to the optical message.

### CROSS-REFERENCE TO RELATED APPLICATIONS

This is a continuation application of PCT/US2012/038301 filed May 17, 2012, which claims priority to U.S. Provisional Patent Application Ser. No. 61/527,378, filed on Aug. 25, 2011, the entirety of the disclosure of which is explicitly incorporated by reference herein.

### STATEMENT REGARDING FEDERALLY-SPONSORED RESEARCH

This invention was made with government support under National Science Foundation Engineering Research Center for Integrated Access Networks (CIAN) under Grant No. EEC-0812072. The government has certain rights in the invention.

### BACKGROUND

The present application discloses systems and methods for a cross-layer optical network node, including a network node to support optically-routed high-bandwidth signals.

Demand for Internet-based services has led to increasing need for capacity, not only at the network core, but at the access and aggregation networks. Optical interconnection networks can provide higher bandwidths with improved energy efficiencies compared to electronic networks at the access and aggregation interface. At least one system for network architecture uses a layered approach to facilitate rapid development via complexity abstraction. Introduction of higher-level functionalities to the physical layer can resolve operational differences introduced by photonic devices coupled with performance and energy requirements of next-generation Internet services.

Further, the deployment of optical-domain based switching can result in a reduction of the number of optical/electronic/optical (O/E/O) conversions. However, the resulting system can lose access to electronic regeneration and grooming techniques and functionalities, which can otherwise be utilized to maintain adequate signal integrity.

### SUMMARY

Systems and methods for a cross-layer optical network node are provided herein.

In one embodiment of the disclosed subject matter, an optical network for routing an optical message from at least one source to at least two destination ports of a plurality of destination ports is provided. The optical network can include at least one input port to receive the optical message, two or more output ports, each configured to communicate with at least one corresponding destination port of the plurality of destination ports, and a plurality of photonic switching nodes coupling the at least one input port with the at least two output ports and configured to route the optical message from the at least one input port to the at least two destination ports.

In some embodiments, the at least two destination ports can include less than all of the plurality of destination ports.

In some embodiments, the optical message can include routing information at a first wavelength and data at a second wavelength, and the plurality of photonic switching nodes can be configured to route the optical message based on the routing information.

In some embodiments, the optical network can include at least one splitter to distribute the optical message to one or more of the plurality of photonic switching nodes. In some embodiments, the number of photonic switching nodes can be referred to as M, and the plurality of photonic switching nodes can be configured to provide M paths between the at least one source and each of the plurality of destination ports. The M paths can be non-blocking paths.

In some embodiments, the plurality of photonic switching nodes can be configured to route the optical message to the at least two destination ports substantially simultaneously. In some embodiments, the plurality of photonic switching nodes includes a programmable logic device.

According to another aspect of the disclosed subject matter, an optical network includes a monitor to measure an attribute of the optical message, and in some embodiments, a photonic switching node, coupled to the monitor and receiving the measured attribute therefrom, is configured to route the optical message between a source and a destination port based on the measured attribute of the optical message.

In some embodiments, the attribute is related to a quality of the optical message. For example, the attribute can be an optical-signal-to-noise ratio (OSNR) of the optical message.

In some embodiments, the monitor includes a delay-line interferometer. The monitor can include a power monitor, and the monitor can include a programmable logic device coupled to the power monitor.

According to another aspect of the disclosed subject matter, an optical network can include a sensor to sample at least one optical message of a plurality of optical messages; and a processor, coupled to the sensor and receiving the sample therefrom, and configured to derive at least one eye diagram corresponding to the at least one optical message.

In some embodiments, the sensor includes a TiSER oscilloscope.

In some embodiments, the processor is configured to determine a quality factor of the at least one optical message from the at least one eye diagram. The quality factor can be a bit-error rate of the at least one optical message. The processor can also provide an indication of a performance of the optical network based on the bit-error rate.

### BRIEF DESCRIPTION OF THE DRAWINGS

FIG. 1 is a diagram illustrating an exemplary network stack architecture for use with some embodiments of the disclosed subject matter.

FIG. 2 is a diagram illustrating an embodiment of a system according to the disclosed subject matter.

FIGS. 3(a)-3(b) are diagrams illustrating embodiments of exemplary components of the system of FIG. 2.

FIG. 4 is a diagram illustrating exemplary signals for use with the system of FIG. 2 and the components of FIGS. 3(a)-3(b).

FIGS. 5(a)-5(b) are diagrams illustrating embodiments of exemplary components of the system of FIG. 2.

FIG. 6 is a diagram illustrating an exemplary component of the system of FIG. 2.

FIG. 7 is a diagram illustrating an exemplary component of the system of FIG. 2.

FIG. 8 is a diagram illustrating another embodiment of a system according to the disclosed subject matter.

FIG. 9 is a diagram illustrating another embodiment of a system according to the disclosed subject matter.

FIGS. 10(a)-10(b) are diagrams illustrating embodiments of exemplary components of the system of FIG. 9.

FIGS. 11(a)-11(b) are diagrams illustrating further details of the system of FIG. 9.

FIGS. 12(a)-12(b) are diagrams illustrating further details of the system of FIG. 9.

FIG. 13 is a diagram illustrating further details of the system of FIG. 9,

FIGS. 14(a)-14(c) are diagrams illustrating embodiments of exemplary components of the system of FIG. 9.

FIG. 15 is a diagram illustrating further details of the system of FIG. 9.

FIGS. 16(a)-16(b) are diagrams illustrating further details of the system of FIG. 9.

FIGS. 17(a)-17(b) are diagrams illustrating further details of the system of FIG. 9.

FIG. 18 is a diagram illustrating further details of the disclosed subject matter.

Throughout the drawings, the same reference numerals and characters, unless otherwise stated, are used to denote like features, elements, components or portions of the illustrated embodiments. Moreover, while the disclosed subject matter will now be described in detail with reference to the Figs., it is done so in connection with the illustrative embodiments.

### DETAILED DESCRIPTION

One aspect of the disclosed subject matter provides systems and methods for a cross-layer optical network node, which can be used, for example, in implementing an optical network having a cross-layer design. An optically-implemented cross-layer design can provide flexible routing with awareness of quality-of-service (QoS) and energy constraints, in addition to optical data signal quality-of-transmission (QoT). Using real-time knowledge of the physical layer offered by cross-layer signaling, optical switching technologies can be implemented to reduce power consumption while improving delivered bandwidth. Dynamic resource allocation of optical components and multilayer traffic engineering can then be achieved while maintaining QoS performance. Routers and switches can be configured to be aware of physical-layer impairments (PLIs) to reduce the total energy consumption.

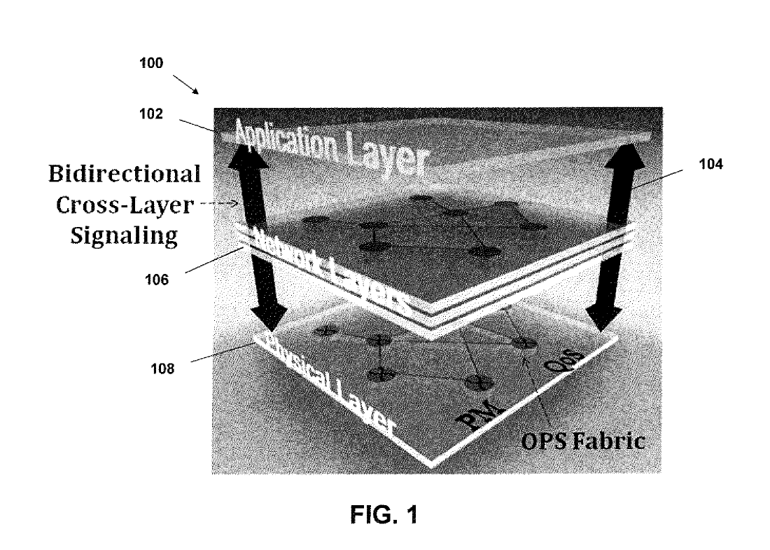

FIG. 1 is a block diagram of a cross-layer network 100 according to an aspect of the disclosed subject matter. The network 100 can support an exchange of bidirectional signals 104 between one or more network layers 106, a physical layer 108 and an application layer 102 within optical-layer switching algorithms. The physical layer 108 can be QoS-aware and can use one or more performance monitoring subsystems.

While cross-layer nodes can be deployed throughout an underlying optical network (for example, in the core), the nodes can also be utilized for the access and/or aggregation networks. Such systems can be implemented with layer-3 (IP) routers; however, electronic switching can have limits, for example with respect to bandwidth and energy efficiency. Though passive optical networks (PONs) can be utilized in the access, utilizing active opto/electronic switches can provide aggregation networks with improved performance and energy efficiency.

A cross-layer node according to the disclosed subject matter, also referred to herein as a cross-layer box (or CLB), can utilize an optical implementation to provide an improved optical network layer 106. Thus, optical switching and routing algorithms that can dynamically introspect the physical layer 108 for optical signal degradations on a packet-by-packet basis, as well as an optical network layer 106 that can detect higher-layer network constraints (for example, QoS and energy), can be provided. The CLB can use optical switching fabrics, which can improve bandwidth data rates via optical packet switching, as well as provide performance monitoring techniques, to achieve improved bit rates with improved optical signal quality.

The CLB can include an optical packet switch to perform optical packet switching (OPS). OPS can be utilized to implement an all-optical switching infrastructure, which can facilitate broadband transmission of wavelength-parallel optical packets via wavelength-division multiplexing (WDM), with improved switching speeds and data-rate transparency. A CLB according to the disclosed subject matter can be used to implement OPS with improved network capabilities via an optical switching fabric with advanced photonic switching functionalities, such as packet multicasting and support for optical QoS constraints. By implementing these higher-layer capabilities lower in the network protocol stack to the physical layer 108, broadband applications can be supported at reduced cost.

Although OPS can improve network capacities by reducing the number of optical/electrical/optical (O/E/O) conversions and using fewer electronic components, systems implemented with fewer electronic components can lose capabilities such as electronic regeneration and grooming, which can be used to preserve signal integrity for end-to-end network links. Accordingly, using such systems can result in the overall network 100 becoming more sensitive to PLIs. For the cross-layer signaling of the CLB, fast PM techniques can be utilized to quickly detect PLIs. Such subsystems can monitor the optical-layer performance to capture the optical signal quality, for example by measuring the bit-error rate (BER) and/or other optical properties such as loss, optical power, optical-signal-to-noise ratio (OSNR), and the like. Based on some or all of these measurements, which can feedback to the upper-layer routing layers, as well as on the higher-layer (IP) constraints, dynamic management of optical switching at the scale of both packets and flows can be performed, and complete optical switching can be implemented. A distributed control plane architecture and routing protocols can then utilize these inputs for cross-layer functionality.

The CLB can provide an optical aggregation network node that can support OPS while simultaneously delivering improved optical QoT and maintaining application-specific QoS constraints. The CLB can support heterogeneous aggregation traffic and relatively high-bandwidth applications, with varying levels of QoS, improving the performance of the switched optical data. Accordingly, optical packet switching can be triggered by real-time optical signal degradation measurements. The option to react to the awareness of the optical channel properties and performance at a packet-rate timescale can also be determined based on energy- and QoS-aware algorithmic inputs. And thus, network 100 can provide various dynamic routing applications and support various multilayer optimization and traffic engineering protocols, to allow for improved QoS and QoT with energy awareness.

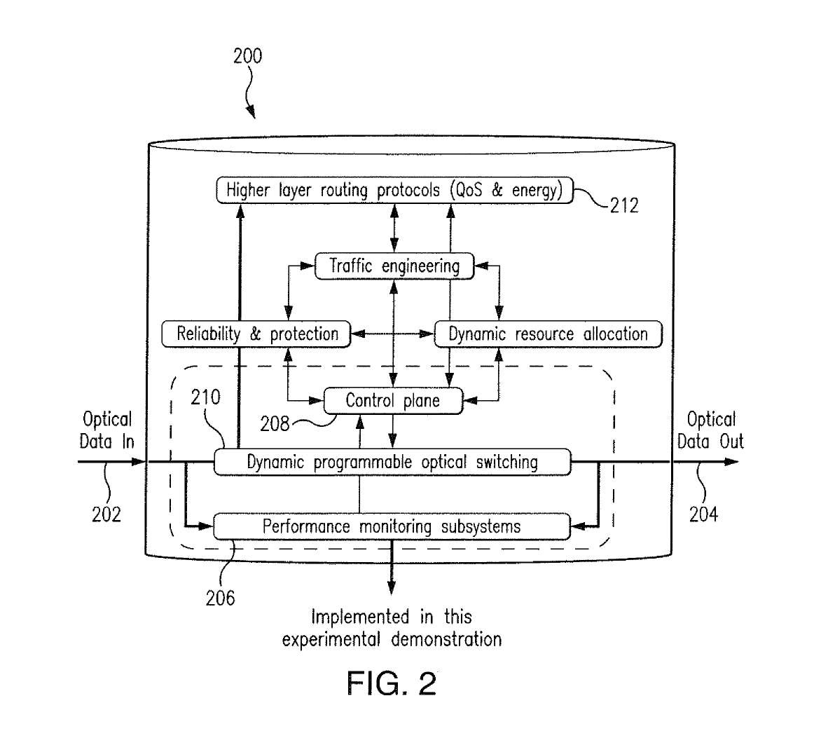

FIG. 2 shows a block diagram of an exemplary CLB 200 according to the disclosed subject matter. The CLB node 200 can include an opto/electronic switching fabric 210 having packet-rate reconfiguration, optical switching capabilities, and advanced physical-layer functionalities; performance monitoring subsystems 206; a distributed cross-layer control plane 208; and cross-layer network routing protocols 212 enabled by higher-layer interactions. The CLB can also support improved routing techniques that can actuate packet-level or flow-based rerouting based on PM measurements, as well as high-bandwidth applications (such as high-definition (HD) video transmission). The CLB can support heterogeneous traffic rates, including multiwavelength optical packets with 8×40-Gb/s wavelength-striped pseudorandom payloads and 4×2.5-Gb/s circuit-switched HD video traffic streaming from a 10-Gigabit Ethernet (10GE) optical network interface card (O-NIC), which can use one or more field-programmable gate arrays (FPGAs), to provide optical data input 202 and output 204. The packet-rate reconfiguration of the fabric can be shown using the performance monitoring (PM) subsystems 206 that can monitor the quality (BER) of the optical signal. Error-free transmission, which can be defined as transmission with BERs less than 10⁻¹² on all payload channels, can be obtained with the wavelength-striped messages, and further, depending on the optical QoT indicated by the control plane 208, a transmission bit rate, for example a bit rate of a video, can be varied.

The CLB can be implemented using commercially-available, off-the-shelf components; however, the CLB 200 can also be designed as an integrated system, having integrated functionalities and a reduced footprint. As shown in FIG. 2 and further discussed herein below, a exemplary CLB 200 can include an optical switching fabric 210; a performance monitoring subsystem 206; and a cross-layer control and management plane 208.

A dynamic programmable optical switching fabric 210 (as shown in FIG. 2) of the CLB 200 according to the disclosed subject matter is described further herein. The fabric 210 can perform bit-rate-transparent all-optical switching, and can particularly support wavelength-striped optical packets.

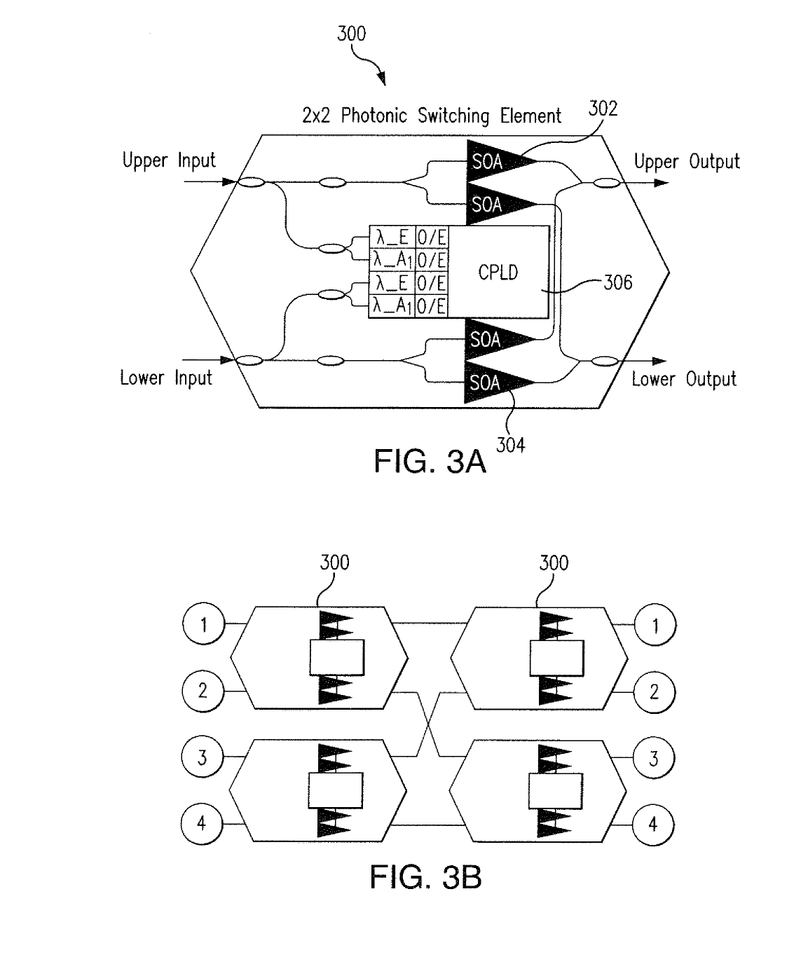

According to an exemplary embodiment of the disclosed subject matter, an exemplary fabric 210 can be implemented using a multi-terabit-capacity optical switching fabric that can include 2×2 broadband non-blocking photonic switching elements (PSEs) 300, which can be organized as a transparent multi-stage 4×4 interconnect and controlled distributedly using complex programmable logic devices (CPLDs). Exemplary PSEs are shown and described in U.S. Patent Application Publication No. 2011/0103799, the disclosure of which is incorporated by reference herein in its entirety. As shown in FIG. 3(a), each 2×2 PSE 300 can be constructed using macro-scale components, including four semiconductor optical amplifier (SOA) gates 302, 304 which can be organized in a broadcast-and-select topology. While PSE 300 as embodied herein is configured with two input ports and two output ports, PSE 300 can have any suitable number of input ports and output ports. The SOAs 302, 304 can provide a relatively wide wavelength band (which can be approximately equal to the International Telecommunication Union (ITU)C-band), in addition to transparency to the optical packets' data format and bit rate, nanosecond-scale switching speeds, and built-in optical gain. In an exemplary embodiment of the disclosed subject matter, optical messages can have lengths on the order of hundreds of nanoseconds, which can span several meters. Since the exemplary packets are longer than the exemplary PSEs 300, no optical storage or buffering is implemented within the elements. Hence, packets can be dropped in the case of message contention within the fabric.

Several PSEs 300 can be connected to create a multistage fabric topology. As shown in FIG. 3(b), four PSE building block structures 300 can be arranged to realize a two-stage, 4×4 switching fabric in this exemplary embodiment. The switching control logic can be implemented within a CPLD 306 located within each PSE 300, which can provide improved programmability to reconfigure the physical connections between PSEs. This topology can utilize a multistage binary banyan design, which can include log₂(N) of identical stages and can create a N×N interconnect to map a relatively large number of ports. Each stage can include N/2 photonic switching elements, connected in a perfect-shuffle arrangement. In the exemplary topology shown in FIG. 3(b), the 4×4 switching fabric can have log₂(N) 2 stages of N/2=2 PSEs (i.e. N=4). Messages can be injected using the input terminals of the fabric, ingressing via the independent input ports, and can be transparently and all-optically routed at each PSE 300.

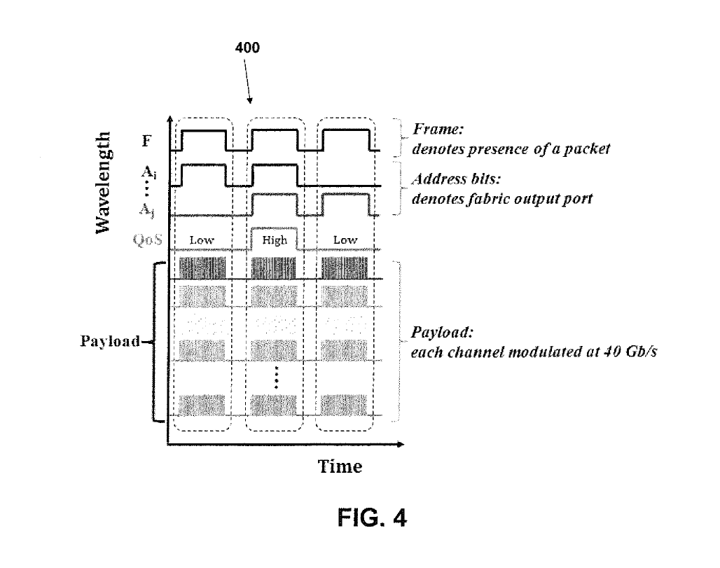

The hybrid opto/electronic switching fabric 210 can enable the fast, synchronous all-optical switching of wavelength-striped messages. An exemplary optical packet structure is shown in FIG. 4. Utilizing wavelength-striping can allow messages to achieve relatively high aggregate transmission bandwidths by leveraging the relatively large bandwidth of WDM and allocating the message data to parallel wavelengths that contain payload data substantially simultaneously. The multiwavelength messages can include control header information (which can include, for example, frame, address, and QoS bits), which can be encoded on a subset of dedicated frequencies, modulated at a single bit per wavelength per timeslot. The control header can include a frame signal F, which can denote the presence of a packet and span the length of the packet; address signals Ai, Aj (as shown in FIG. 4), denoting the packet's destination port within the switching fabric; and a QoS information bit, denoting the packet's priority class (as indicated by a higher-layer protocol). By allowing the control wavelengths to remain high for the duration of the optical message, the PSE's switching state can remain substantially constant as messages propagate through the fabric. Concurrently, the payload data of the packet can be fragmented and modulated at a relatively high data rate (for example, at 40 Gb/s per data payload channel) on the rest of the supported frequency band.

The OPS design can allow packet-rate control header processing, in which, for example, the message header can be decoded at each PSE 300 and a routing control decision can be made upon reception of the leading edge of the packet. The electronic control logic of the PSEs can be distributed among the individual PSEs using high-speed programmable logic (for example in the CPLDs), which can provide improved routing flexibility. The message payload data and routing control headers can be transmitted concurrently to the PSEs and propagate together end-to-end in the fabric 210. At each of the 2×2 PSEs, the routing decision can be based on the control header extracted from the packet. The leading edge of the optical packet can be detected and received at one of the input ports. The framing and address bit signals can be extracted immediately using fixed wavelength filters and p-i-n optical receivers. The switching state of the exemplary PSE 300 can be based on the information encoded in the optical header, which can be recovered from the incoming packet and processed by electronic circuitry. The CPLD can electronically drive the appropriate SOA gates, and the optical messages can then be routed to their encoded destination, or dropped if there is contention. The switching control can be distributed among the PSEs using combinational logic, and can be configured to have no additional signals exchanged between them. The PSEs 300 also can be configured to not add/subtract information to/from the optical messages. The PSE logic can be configured to route payload information transparently using one of the four SOAs, rather than decode the payload information. Successfully switched messages can set up end-to-end transparent lightpaths between fabric terminals. The use of reprogrammable CPLDs can facilitate reconfigurability and support for different routing protocols and logic.

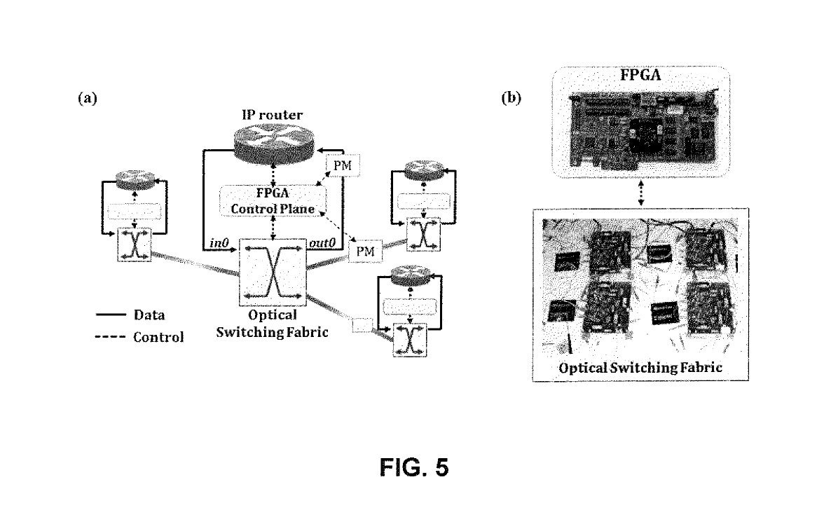

The SOAs' switching speed and the electronic logic can provide an optical fabric having nanosecond-scale reconfiguration response times. Such a switching fabric can perform relatively fast switching and path provisioning in the case of router failure or link degradation, and thus can recover and potentially route around PLIs. An exemplary network architecture configured to provide switching fabric reconfiguration is shown in FIG. 5(a). An exemplary FPGA and optical switching fabric are shown in FIG. 5(b).

According to an exemplary embodiment of the disclosed subject matter, a CLB 200 can include a packet-level performance monitor (PM) 206, which can facilitate evaluation of the optical data on a packet-by-packet basis. In an exemplary embodiment, a PM can be implemented using a photonic time-stretch enhanced recording (TiSER) oscilloscope, which can provide digitization of high-speed signals and realize a diagnostic, PM tool for optical links. TiSER can extrapolate the BER of the optical packets on a message-timescale. An exemplary TiSER oscilloscope is shown and described in U.S. Patent Application Publication No. 2010/0201345, the disclosure of which is incorporated by reference herein in its entirety. In another exemplary embodiment, a PM module 206 can monitor the packet-rate optical-signal-to-noise (OSNR), which can be monitored on a packet-by-packet basis, to determine signal integrity.

In an exemplary embodiment, TiSER can be inserted in the CLB 200 to allow dynamic cross-layer interactions whereby TiSER can generate real-time eye diagrams, characterize PLIs, and monitor the BER. These measurements can be utilized to reconfigure the optical switching fabric with rapid capacity provisioning using cross-layer network routing algorithms. TiSER can utilize photonic time-stretch technology to effectively slow down electronic signals before digitization, which can mitigate potential bandwidth limitations of analog-to-digital (A/D) converters in receivers and allow the capture of the optical eye diagrams of the 40-Gb/s payload channels of the packets. In order to provide performance monitoring, the BER of the signals can be determined on a packet timescale from the eye diagrams. TiSER can allow each data channel in the multiwavelength packet to scale to higher data rates with reduced BERs.

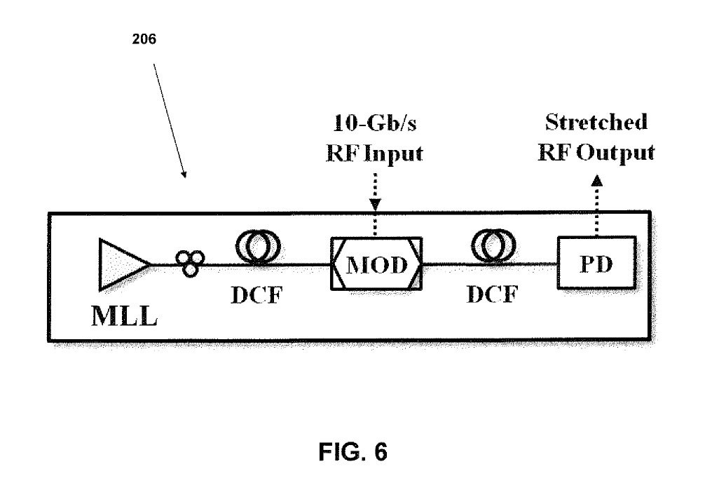

FIG. 6 shows an exemplary PM 206, implemented using a TiSER oscilloscope. The TiSER oscilloscope can capture discrete segments of high-bandwidth electronic signals and stretch the signals in time before digitizing, which can effectively multiply the sampling rate and analog bandwidth capabilities of the back-end A/D converter by a stretch factor. The sampled segments can then be used to construct eye diagrams in equivalent-time mode. The resulting sampling modality, which can include bursts of captured measurement samples, can be termed real-time burst-mode sampling (RBS). RBS can allow for the capture of fast, non-repetitive signals, via its real-time capabilities, while utilizing relatively lower-speed A/D converters, and thus be implemented at reduced cost and with reduced energy-consumption. Accordingly, high-speed signals can be captured using relatively slower, commercially-available digitizers, and can provide improved measurement functionality and performance. TiSER can be configured to capture eye-diagrams of data signals up to 45 Gb/s and provide up to 100-Gb/s return-to-zero differential quaternary phase-shift keying (RZ-DQPSK).

As shown in FIG. 6, in this embodiment, the exemplary PM 206, implemented using a TiSER oscilloscope, can include a mode-locked laser (MLL) to generate broadband (for example, 20 nm), ultra-short optical pulses at a 36-MHz repetition rate. A −20-ps/nm dispersion-compensating fiber (DCF) can then create chirped pulses with a sufficient time aperture to capture a sufficient number of bits per pulse (for example, 16) of the 40-Gb/s RF data. A 40-Gb/s Mach-Zehnder (MZ) intensity modulator can encode the 40-Gb/s data signal over the chirped pulses. Propagation through a span of −1310-ps/nm DCF can stretch the modulated optical pulses in time, which can provide a stretch factor of approximately 70. A 10-Gb/s photodetector (PD) can receive the pulses and create an electronic RF signal, which can be a stretched version of the original with reduced bandwidth. A commercial A/D digitizer with 2-GHz bandwidth can be used, and the eye diagram can be constructed using the recorded data by removing an integral number of data periods from the stretched time scale.

The exemplary PM 206, implemented as a TiSER oscilloscope, can be implemented in a 19-inch Rackmount Chassis, which can accommodate the electronic A/D converter. The PM 206 can be configured to integrate all of the pre-processor components in the TiSER chassis. The inputs can include a RF signal, a RF trigger, and a MZ modulator bias voltage (for example having less than 4 Vdc). The output ports can include the stretched RF signal, the digitized data, and clock. The extrapolation of the BER of the packet can allow for measurements to be performed with improved speed and can allow for measurements on a packet-by-packet basis.

According to an exemplary embodiment of the disclosed subject matter, the CLB 200 can include a control plane 208 to support packet-rate reconfiguration and feedback from the optical layer. The control plane 208 can be implemented using an external FPGA device, which can control signals from the higher layers and/or embedded physical-layer PM devices triggering recovery and rerouting messages on the optical layer. The fabric can thus be reconfigured based on interactions between the optical and network layers. The use of the FPGA controller, together with SOA-based nanosecond switching, can provide improved cross-layer fabric recovery.

Improved optical-layer reconfiguration can allow the underlying optical network to account for higher-layer/IP parameters. If an IP router fails, or is placed into sleep mode to reduce energy consumption, lightpaths between end nodes in an all-optical network can be maintained by reprovisioning the optical connections around the failed or sleeping routers. The packet-rate reconfiguration of the switching fabric can also facilitate optical lightpath bypasses.

With these components, the CLB can provide advanced switching capabilities, including the support for optical packet- and circuit-switched data, and QoS-based switching. The capabilities of the CLB include the measurements of the BER of the optical packets in order to enable packet protection switching and message rerouting. Additional adaptations include optical packet multicasting and other advanced switching functionalities.

In an exemplary experiment, several functionalities of the CLB 200 according to the disclosed subject matter are demonstrated. For example, the switching fabric 210 of the CLB 200 can support the aggregation of multiple data rates via the simultaneous transmission of: 8×40-Gb/s wavelength-striped optical packets, with each payload wavelength using a 40-Gb/s nonreturn-to-zero (NRZ) signal with an on-off-keyed (OOK) format, carrying pseudorandom bit sequence (PRBS) data; and 4×3.125-Gb/s 10 Gb Ethernet (10GE)-based HD video data.

The CLB 200 can simultaneously transmit of both pseudorandom traffic and real video streams. Support for concurrent packet- and circuit-switched lightpaths within the switching fabric at a given time can also be provided.

Improved packet-scale reconfiguration of the switching fabric 210 is illustrated using the FPGA-based control plane 208 with the two distinct data streams. First, the QoT of 8×40-Gb/s optical packets can be shown to be assessed using TiSER, using one of the 40-Gb/s optical payload channels at an output port of the fabric. Upon the detection of a failure or a degraded link (i.e. as indicated by TiSER), the control plane 208 can then signal the switching fabric 210 to modify its switching state to reroute the optical packets and dynamically avoid the PLI.

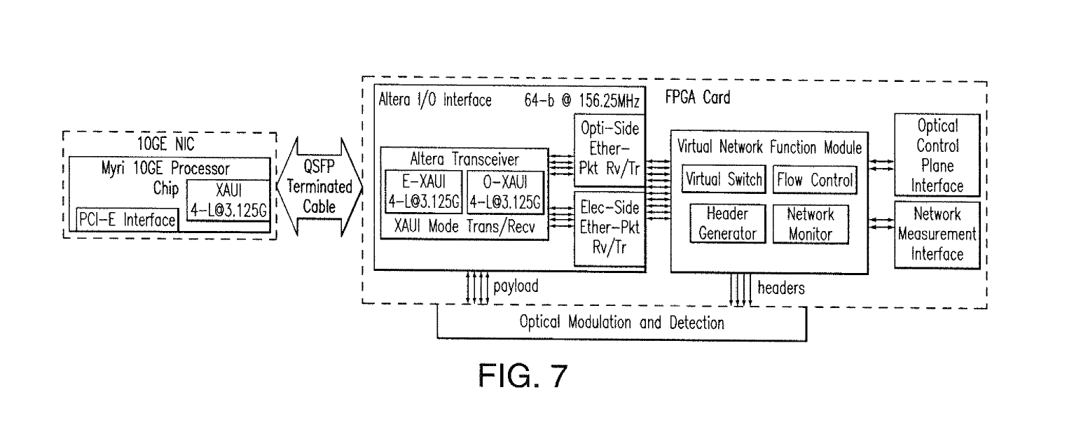

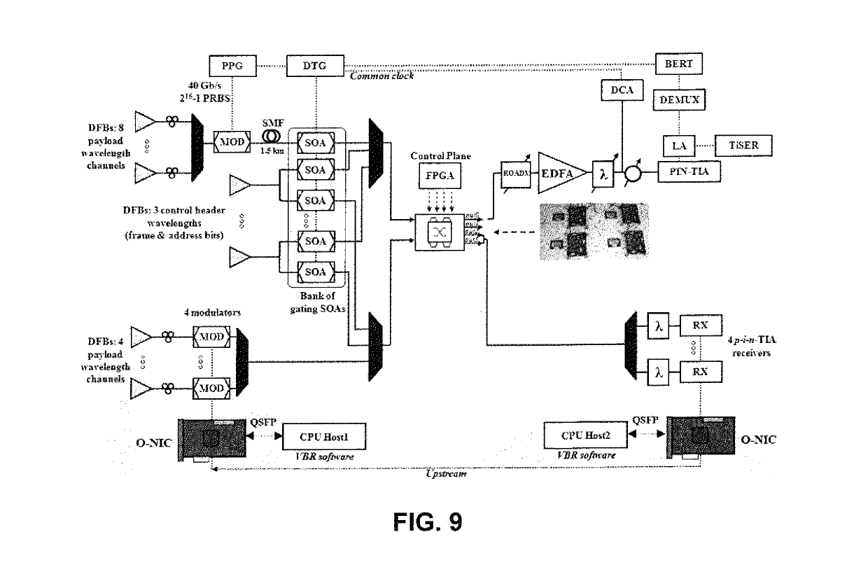

Further, a 10GE O-NIC can be configured to transmit circuit-switched 10GE video data through the switching fabric 210 without distortion or frame loss. An exemplary 10GE O-NIC can be implemented using a commercially-available 10GE NIC extended by a separate high-speed FPGA connected via a 10 Gigabit Attachment Unit Interface (XAUI). The XAUI, as embodied herein, can support four lanes of 8b/10b encoded 3.125-GBaud signals, with an aggregate data rate of 10 Gb/s. FIG. 7 shows an exemplary O-NIC configuration. As embodied herein, on the electronic side, an Ethernet packet can be transmitted from the CPU to the O-NIC, where data can be de-serialized, aligned, 8b/10b decoded in the transceiver and passed to various self-defined modules. These modules can be configured to, for example, parse the Ethernet header information, transfer clock domains and buffer effective data packets. The parsed information can then be delivered to a virtual network function module, which can, for example, perform further analysis of the parsed information and/or control an optical switching fabric. On the optical side, the exemplary XAUI-based Ethernet payload can utilize WDM provided by the optical domain. In this manner, the 4×3.125-Gb/s optical data can be transmitted over the fabric. Further details of the 10GE O-NIC are shown in the lower shaded region of FIG. 9, which is further described below.

In case of a higher-layer router failure and/or the detection of optical signal degradation, the FPGA control plane 208 can signal the fabric 210 to perform a nanosecond-scale reconfiguration and allow the video data to be transmitted upon restoration of the optical link. Additionally, the cross-layer adaptability of the application layer to the physical layer can be provided using variable-bit-rate (VBR) video transmission over the fabric 210, which is described further herein below.

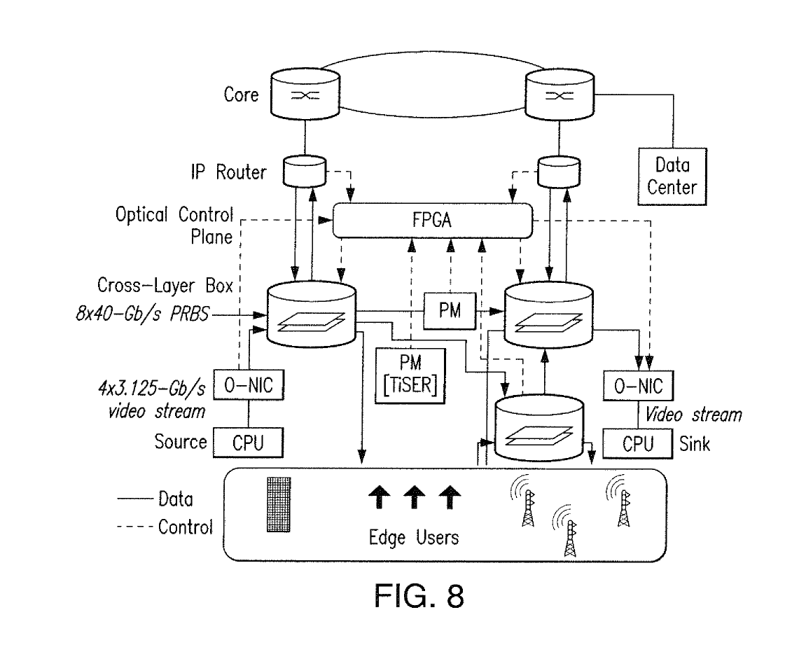

FIG. 8 shows a diagram of an exemplary high-level network architecture including several CLBs 200 in a mesh topology. The CLBs and the FPGA control plane can be interconnected with underlying control and data links. The control plane can interface the CLBs and physical-layer PM devices with the higher-layer router nodes. The various different data streams within the CLB infrastructure are shown. These functionalities can operate on the timescale of a nanosecond-scale optical packet to reduce traffic loss and packet dropping.

### Example 1

An example demonstrates an embodiment of a CLB 200 using its reconfigurable multi-terabit optical switching fabric, packet-level performance monitor, and control plane to show the transmission of pseudorandom and real video data. As an example of the performance, the system aggregates the data from a high-bandwidth source (i.e. the 8×40-Gb/s wavelength-striped packets), with circuit-switched video stream using the O-NIC (i.e. the 4×3.125-Gb/s multiwavelength video data). A diagram of the exemplary system described herein is shown in FIG. 9.

The per-packet reconfiguration of the switching fabric uses the FPGA control plane in a two-part process, with both parts occurring simultaneously. The optical fabric is simultaneously operated with the two traffic streams, and is shown to reconfigure at a nanosecond packet rate. The first part of the demonstration leverages the large multi-terabit capacity of the switching fabric, as well as the ability to leverage TiSER to monitor a single 40-Gb/s payload channel (as shown in the upper shaded region of FIG. 9), while the second utilizes a 10GE-based interface to support video transmission (as shown in the lower shaded region of FIG. 9). The two parts are discussed herein below.

The fabric is demonstrated to transmit both data streams successfully and with BERs less than 10⁻¹². The nanosecond reconfiguration of the fabric of the CLB upon the detection of either a failed higher-layer router and/or degraded optical signals is also demonstrated. In this way, the optical-layer data can be rerouted within the switching fabric to maintain a high QoT as determined by the embedded performance monitor.

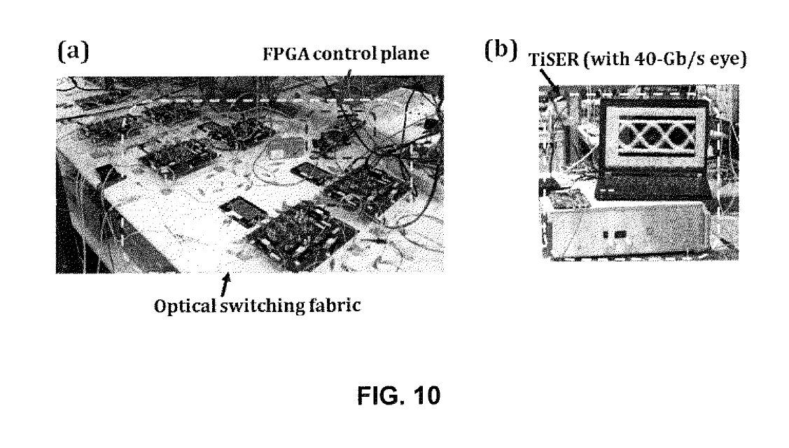

The example shows that the optical fabric can switch optical packets based on the higher-layer failure state denoted by the control plane. FIG. 10(a) shows an exemplary infrastructure with the 4×4 optical switching fabric and the FPGA-based control plane.

A two-stage, 4×4 fabric design is implemented using four PSEs. Each element uses commercially-available off-the-shelf components, including four individually-packaged SOAs, passive optical devices and couplers, fixed wavelength filters, low-speed 155-Mb/s p-i-n photodetectors, and electronic circuitry. The electronic routing decision logic is synthesized in high-speed CPLDs. The PSEs are able to decode optical control bits and maintain their routing state based on the extracted headers while concurrently handling wavelength-striped data transparently in the optical domain.

At each switching stage, the wavelength-based routing signals are extracted, with each PSE decoding four control header bits (two per input port) for routing: one frame and one address bit. The CPLD uses the header bits as inputs in a programmed routing truth table, then gates on the appropriate SOAs. At each 2×2 PSE, the extracted frame bit denotes the presence of a wavelength-striped packet; then, according to the detected address signal, the CPLD gates the suitable SOA for the packet to be routed to the upper (or lower) output port of the PSE (for example, as shown in FIG. 3(a)). The combinational logic synthesized in the CPLD uses the two-bit control header as follows: upon the presence of the frame bit (F), the CPLD then examines the address bit. If the address bit is low, the message is directed to the upper output port; if the address is high, the message is transmitted to the lower output port. While the PSE as embodied herein is configured to receive a message on a single input port, the PSE can be configured to detect messages ingressing on a plurality of input ports, for example two or any suitable number of input ports.

The SOAs are operated in the linear regime, and their inherent optical amplification compensates for the insertion losses of the passive optical components. The SOAs are mounted on an electronic circuit board (FIG. 10) with the required electronic components, current driver chips, and low-speed optical receivers. It should also be noted that although certain SOAs are used here to provide a convenient platform for switching functionality and testing described in this example, other CLBs can leverage other low-energy devices.

The exemplary setup includes a failure recovery scheme that allows the 2×2 PSEs of the optical switching fabric to account for router failures. Upon the detection of a failed/degraded link, the control plane signals the fabric to reconfigure its switching state to route around the failure and ultimately avoid further degraded packets. The fabric operating with the two traffic streams is demonstrated for two explicit cases: (i) an online router (i.e. when packets are correctly switched to their desired output ports), and (ii) an offline router (i.e. the router or following optical link is down, thus the fabric reroutes the packets according to predetermined recovery switching logic).

The FPGA control plane can be implemented, for example and without limitation, using an Altera Stratix II FPGA. FIG. 10(a) shows the FPGA as realized in the example. The FPGA can accept external inputs (e.g. electronic signals from a router and/or PM modules) and then generates failure signals for the PSEs. The routing logic synthesized within the CPLDs is adapted to accept these electronic failure signals to either route normally (for an online router, packets are switched accordingly), or route around the failure (for the offline/failed router, packets are rerouted to ensure that no messages are transmitted to the link). As in the exemplary network architecture configured to provide switching fabric reconfiguration shown in FIG. 5(a), if the router is offline, packets that would have been transmitted to the router are instead rerouted to another output port if there is no contention; otherwise, they are dropped. The recovery scheme deflects packets to an alternate port on the same PSE to mitigate failure on a given link.

In this example, an Altera FPGA circuit board that contains eight flip switches and 28 general purpose input/output (GPIO) pins is utilized to implement the control plane. As embodied herein, the flip switches are manually-operated to signal a router failure to the FPGA. Each PSE is coupled to one or more of the GPIO pins of the FPGA, and in response to the signaled router failure, the FPGA signals updated routing information to the appropriate PSEs using the GPIO pins.

The CLB of the example can be demonstrated by performing packet-rate monitoring and fabric reconfiguration. The fast reconfiguration of the switching fabric is described as it operates with a multi-terabit load. The switching fabric supports 8×40-Gb/s wavelength-striped optical packets, which are injected in the fabric and switched depending on the router failure state as signaled by the FPGA-based control plane. In the example, TiSER is used as a PM module to monitor the link and indicate whether the fabric has successfully reconfigured its switching state.

The payload information of the multiwavelength packets includes data encoded on eight separate payload channels, which are each modulated at 40 Gb/s (per wavelength channel). The 8×40-Gb/s optical packets have a total aggregate bandwidth of 320 Gb/s (per fabric input port), showcasing the multi-terabit capacity of the switching fabric.

The upper shaded region in FIG. 9 shows the setup for the 8×40-Gb/s packet generation and signal integrity analysis. The payload channels are generated using eight separate continuous-wave (CW) distributed feedback (DFB) lasers each connected to a polarization controller (PC). The payload wavelengths range from 1533.12 mu (ITU C58) to 1560.61 nm (ITU C21), with a minimum frequency spacing between two adjacent payload channels of 100 GHz. The outputs of all eight lasers are passively combined onto a fiber using an optical coupler and then modulated simultaneously with a high-speed radio frequency (RF) signal, implemented as a 40-Gb/s NRZ-OOK signal that carries a 2¹⁵−1 PRBS. A single commercial 40-Gb/s LiNbO₃ amplitude modulator is utilized, which is driven by the 40-Gb/s RF signal that is generated using a high-speed pulse pattern generator (PPG). The multiwavelength channels are then passed through a 1.5-km span of SMF-28 to decorrelate the data and subsequently to an external SOA for packet gating. The packets are 32-μs in duration, allowing for TiSER to acquire a sufficient number of samples (1500 sample points) to capture the eye diagram of a single packet.

In this example, the control header signals are created independently using three separate CW-DFB laser sources at the suitable wavelengths for the frame (1555.75 nm (C27)), and two switching fabric address bits for the two-stage topology (1531.12 nm (C58), and 1543.73 nm (C42)). Each of the control DFB lasers are connected to a separate packet gating SOA. The control and multiwavelength payload channels are then gated into the 32-μs long packets using a data timing generator (DTG) and the bank of gating SOAs. The DTG act as a programmable electronic pattern generator and is synchronized with the 40-Gb/s clock. The address bits are encoded appropriately high or low for each packet to ensure correct switching through the fabric. The channels are then multiplexed together using a passive combiner, yielding wavelength-striped optical packets including three control bits and eight 40-Gb/s data streams. A similar packet-generation setup can be used concurrently for each set of control and payload signals to form a distinct packet pattern for the each of the input ports of the fabric.

The wavelength-striped optical messages are switched within the fabric and correct path routing is verified. At the output of the realized switching fabric, the multiwavelength packet is monitored and examined using an optical spectrum analyzer (OSA) and high-speed sampling oscilloscope (i.e. a digital communications analyzer (DCA)). The packet analysis system also allows the wavelength-striped packet to propagate to a tunable grating filter (here, a narrow-band reconfigurable optical add-drop multiplexer (the ROADM shown in FIG. 9)), selecting one 40-Gb/s payload stream for signal integrity analysis and rejecting the accumulated amplified spontaneous emission (ASE) of the SOAs. The payload channel is then sent to an erbium-doped fiber amplifier (EDFA), another tunable filter, and a variable optical attenuator (VOA). The signal is then received by a 40-Gb/s p-i-n photodiode followed by a transimpedance amplifier (TIA). A limiting amplifier (LA) is also utilized with two differential output ports.

One of the ports of the LA is connected to an electrical demultiplexer, which time-demultiplexer the signal such that the BER can be evaluated using a commercial 10-Gb/s BERT. The DTG is used to gate the BERT to measure the errors over the duration of the packet. No clock recovery is performed in this example, and a common clock synchronizes the DTG, pattern generator, BERT, and electrical demultiplexer.

The other differential output of the LA is connected to TiSER, which can support the capture of 40-Gb/s eye diagrams. Less dispersive fiber is used for pre-chirping to avoid the dispersion penalty, which arises from low-pass filtering due to the interference of the 40-Gb/s signal sidebands from dispersion.

In this example, TiSER monitors a single 40-Gb/s channel at the output of the fabric. FIG. 10(b) shows the TiSER chassis as it was inserted in the switching fabric test-bed. The data is sampled using a commercial A/D digitizer with 2-GHz bandwidth, capturing up to 20 GSamples/s, via a real-time scope.

The example demonstrates correct functionality of the switching fabric, with correct addressing and switching. Wavelength-striped optical packets with 8×10-Gb/s payloads are correctly routed through the fabric. Further, TiSER allows the QoT of an egressing optical packet to be evaluated offline using advanced signal processing techniques. At the output of the switching fabric of the CLB, the QoT of a high-bandwidth optical packet is determined by assessing one of the 40-Gb/s optical payload channels. TiSER obtains a sufficient number of samples to generate a 40-Gb/s eye diagram from a single optical packet. Using the sampled eye diagram, the BER is then estimated by TiSER using a calibrated signal processing algorithm that rapidly determines the quality of the signal.

In the example, the TiSER scope is used to monitor the egression of optical packets from the switching fabric of the CLB and allows the observation of the fabric's fast reconfiguration. A FPGA control plane can inform the fabric of a router failure or degraded link; the cross-layer control plane can then signal the switching fabric to switch routes to protect the optical packet transmission and avoid the point of failure. In this way, the packet stream can be rerouted around the failed or degraded link. The monitoring and fabric recovery capability utilizes the 40-Gb/s payload channels, and the signal from the higher-layer router to the control plane is implemented by adjustment of a flip switch on the FPGA circuit board. Thus, offline signal processing is used to extrapolate the BER. Alternatively, a circuit board with on-board FPGA and low-speed A/D can be used to enable the real-time, online BER extrapolation. The real-time estimation of the packets' QoT will be more rapid, and the packet-scale BER measurement can then be leveraged in the cross-layer infrastructure to denote the optical signal quality with a packet rate.

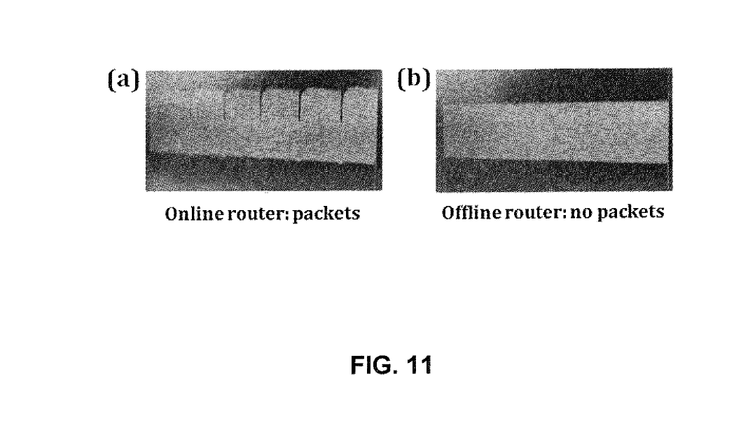

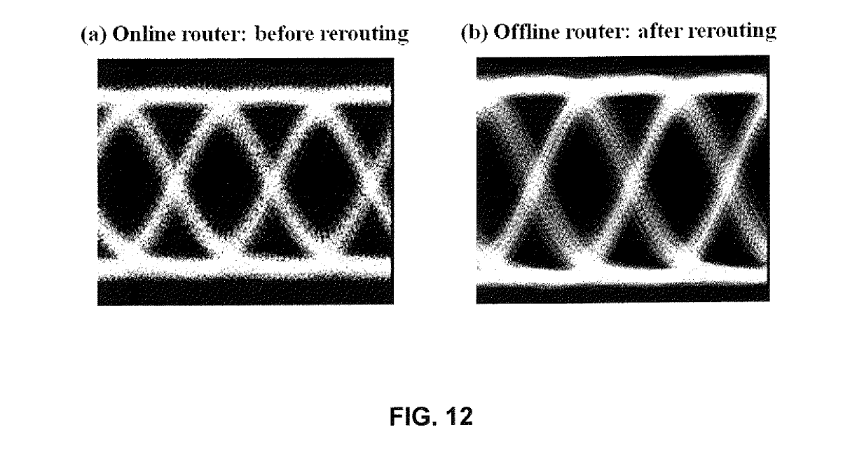

TiSER is connected to one of the output ports of the switching fabric, identified as out0 in FIG. 9. FIG. 11(a) shows an exemplary reconfiguration state of an online router, as depicted by the A/D. Using the low-speed digitizer realized with TiSER, the optical packet stream is seen to be transmitted to the desired router link (i.e. out0). Correspondingly, FIG. 11(b) shows an exemplary reconfiguration state of an offline router. In this case, the output of the TiSER digitizer displays no packets since they are rerouted to an alternate port (i.e. out1 in FIG. 9) within the switching fabric to avoid the packet loss of transmitting to a failed/degraded link. The 40-Gb/s eye diagrams of a single optical packet (at λ=1538.98 nm) as captured by TiSER during the fabric reconfiguration are shown in FIGS. 12(a)-(b). FIG. 12(a) shows the 40-Gb/s TiSER-measured eye diagram at the fabric port corresponding to the router (out0) when the router is online, while FIG. 12(b) depicts the 40-Gb/s TiSER-captured eye diagram at the rerouted fabric port (out1). When the router is offline or the following link is shown to be degraded, the cross-layer platform signals the optical packets to be redirected to an available output in the switching fabric (for example, out1). Minimal degradation in the eye due to switching and rerouting is shown, as indicated by the eye diagrams in FIGS. 12(a)-(b). Further, BER estimation algorithms also show that the rerouted packets exhibit improved BER performance in the offline router case, as compared to the online router scenario.

Using the packet analysis system described herein above, BER measurements with a commercial BERT show that all packets are switched through the fabric with error-free performance, attaining BERs less than 10⁻¹² on all eight payload wavelength channels.

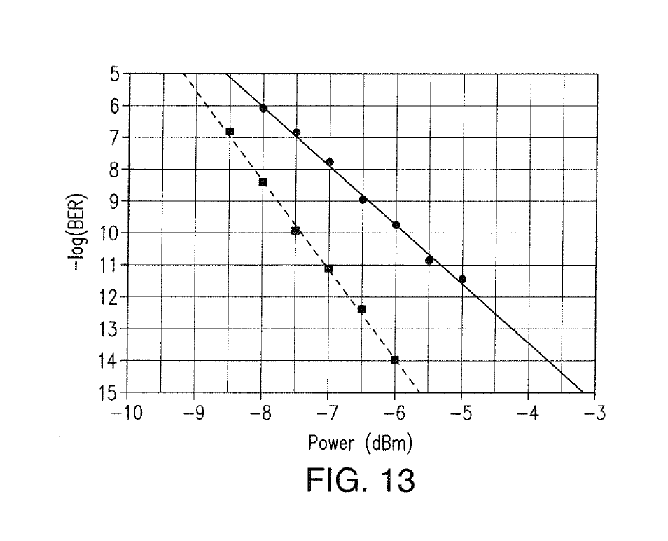

To demonstrate the packet-level BER estimation of TiSER, BER measurements using TiSER alone are performed rather than using the traditional BERT system, which allows for more rapid BER measurements. TiSER samples the data at varying optical power levels, and offline signal processing techniques are then used to estimate the BER. As indicated by TiSER, the error-free transmission is confirmed and the resulting TiSER-generated BER data is plotted with respect to the received power. As shown in FIG. 13, 40-Gb/s sensitivity curves are obtained resulting from the TiSER measurements, and a 1.3-dB power penalty is obtained for the complete system.

The ability of the switching fabric to reconfigure in the face of failures while supporting multi-terabit traffic is shown. The cross-layer platform can be implemented using fast hybrid opto/electronic switches that can be integrated with real-time PM modules. The TiSER oscilloscope is used here as the embedded PM, showing rapid BER extrapolation capabilities at the packet rate. The demonstration of TiSER to monitor the 40-Gb/s channels allows the fast measurement of the optical QoT with a message granularity.

The ability of the CLB to support multimedia/video applications is also demonstrated via the transmission of a 10GE-based HD video traffic using 4×3.125-Gb/s streams through the CLB, which occurs concurrently with the high-speed PRBS data operation. A 10GE-based O-NIC, as described herein, can be utilized to enable Ethernet-based video traffic through the switching fabric of the CLB without distortion or frame loss. In response to router failure and/or optical link impairments, the cross-layer FPGA control plane allows for the switching fabric to reconfigure with a nanosecond timescale. This allows the video data to be recovered and to be transmitted seamlessly upon restoration of the optical network link. Cross-layer interactions between the application and physical layers are also shown using a VBR operation of the data switched by the fabric.

The lower shaded region in FIG. 9 shows the setup for generating the 4×3.125-Gb/s wavelength-striped video streams as implemented in this part of the example. The O-NIC uses commercial 10GE network interface cards (NICs) in the two computer end nodes (host1 and host2), connected by Quad Small Form-factor Pluggable (QSFP) cables. The NICs are extended by high-speed FPGA devices, which are connected via 10-Gigabit Attachment Unit Interface (XAUI). The XAUI allows the system to support four separate lanes of 8b/10b-encoded 3.125-GBaud signals with an effective data rate of 10 Gb/s. Ethernet packets are transmitted via the end hosts to the O-NIC. The logic within the FPGA deserializes and aligns the data, and adds the 8b/10b encoding in the transceiver. The information is then passed to several self-defined modules in the FPGA in order to parse the Ethernet header information and buffer the effective data packets. The XAUI-based Ethernet payload is then converted to the optical domain, utilizing the wavelength parallelism provided by WDM. The O-NIC produces 4×3.125-Gb/s Ethernet-based video streams end-to-end.

Four CW-DFB lasers at optical payload wavelength channels of 1548.51 nm (C36), 1547.72 nm (C37), 1546.92 nm (C38), and 1546.12 nm (C39), are used to create the optical link. As described above and shown in FIG. 9, the Ethernet data is generated by the source host (host1) and corresponding FPGA, which drive four separate LiNbO₃ modulators. The example uses two 10GE NICs connected to 64-bit computers (CPUs), and the two 0-NICs are implemented using development boards from PLDA with embedded Altera Stratix II GX FPGAs and transceivers configured with the XAUI protocol.

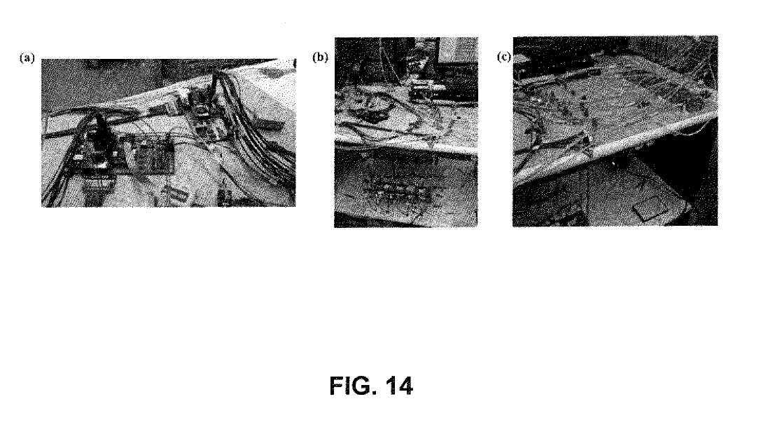

The multiwavelength data is then combined with the appropriate control headers and injected in the switching fabric of the CLB. Circuit-switched paths are established for the video streams, connecting one input port (in3) with one output port (out2). At the output of the fabric, each of the four data streams is appropriately filtered and received using four p-i-n receivers with TIA and LA pairs, and transmitted to the transceivers on the destination host's FPGA board. The upstream traffic is looped back electronically. FIGS. 14(a)-(c) shows exemplary optical components used to implement the O-NIC.

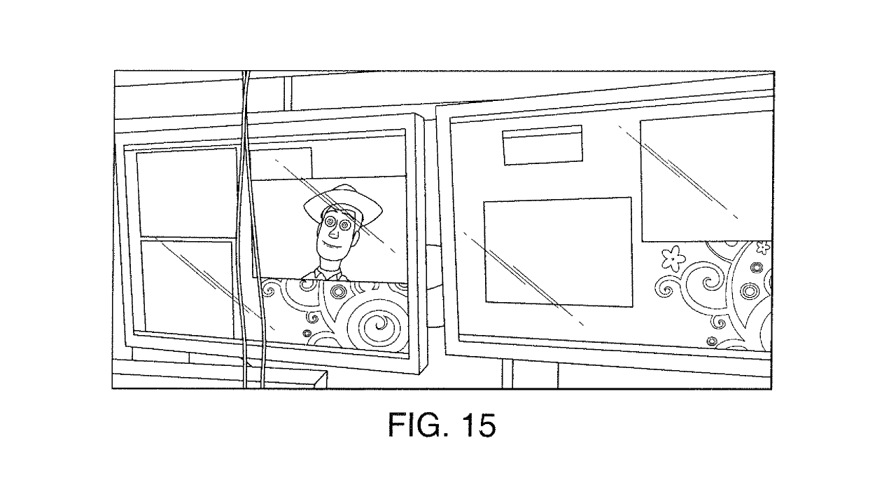

Concurrently with the pseudorandom traffic transmission, the O-NIC is used to demonstrate HD video streaming over the two-stage switching fabric. The video is observed to be transmitted without distortion or the loss of frames. The video is configured to play on the source host CPU, transmitted on the optical fabric, then played on the monitor connected to the destination host CPU. FIG. 15 shows the two host computer monitors. The source host plays a recorded video through the 10GE-based optical network link. The video is shown without distortion on the destination host.

The reconfiguration of the switching fabric is again shown for the video streaming in which the control plane can signal the switching fabric to reroute the optical packets in the detection of an optical link degradation. During the lightpath rerouting, the video is paused for a short time while the Ethernet link is restored, then is shown to continue playing.

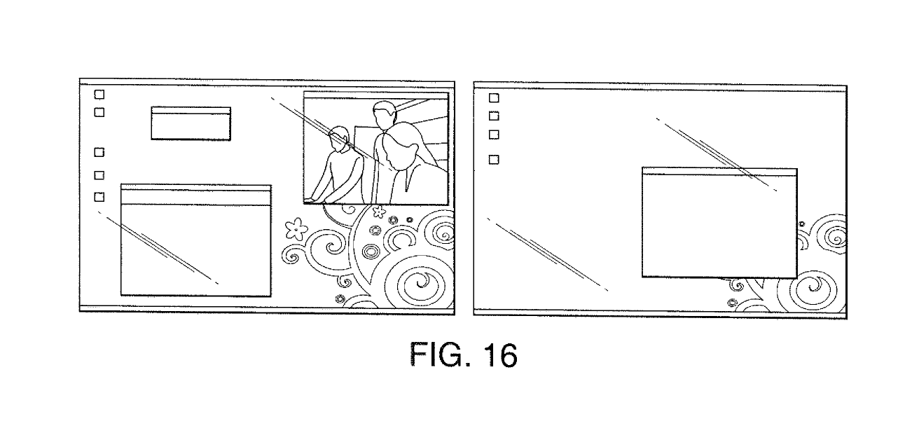

Further, to demonstrate the cross-layer adaptability of the application layer with the optical physical layer, a VBR transmission is set up over the switching fabric of the CLB. The two host computers that are connected through the optical fabric leverage the 10GE interface described above, effectively creating a two-host private IP network. The source host (host1) is physically connected to an HD web camera, and the destination host (host2) is shown to seamlessly display the images originating from the camera. The transmitted video is encoded using software based on FFmpeg and streamed over the fabric in the form of User Datagram Protocol (UDP) packets. FIGS. 16(a)-(b) show the real-time streaming-over-optics of the camera images.

Additionally, the video encoding is configured such that the codec parameters can be modified on-the-fly. The system switches between high bit rates (supporting high-quality video) and degraded bit rates (supporting low-quality video) upon receiving signaling commands embedded in specific UDP packets. The signals are sent from host2 (destination) to host1 (source). Additionally or alternatively, this information can be carried using out-of-band signaling to another network interface on the source host.

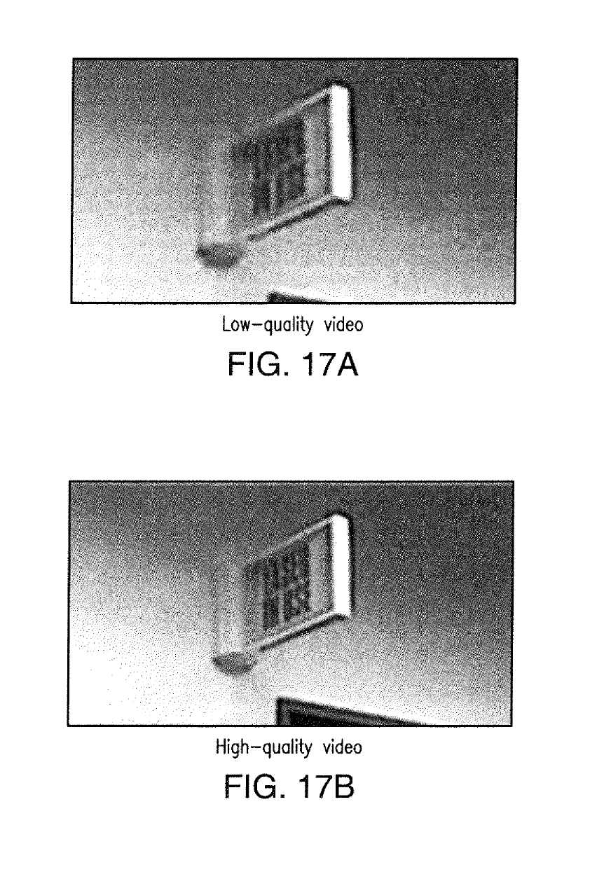

FIGS. 17(a)-(b) show the screenshots of the high-quality (FIG. 17(a)) and low-quality (FIG. 17(b)) video images that result from the VBR demonstration. As an example, an application can transmit a high-quality video as a result of the measured link quality. If a more degraded link is measured, the cross-layer interaction allows for the application to dynamically adjust the bit rate of its transmitted video to cater to the link quality.

In this example, the cross-layer signaling is performed manually, where the control UDP packets are sent by user command. Alternatively, various PM subsystems can detect the QoT degradations and/or increases in BER on a link, and subsequently signal the control plane. The control plane can then instruct the transponders at the sending and/or receiving terminals to reduce the bit rate of the link for improved impairment resiliency, and inform the higher-layer application layer of these changes to allow for the network to cope with reduced resources.

### Example 2

According to another aspect of the disclosed subject matter, optical packet multicasting can be utilized in a switching fabric as a high-bandwidth application to provide improved functionality and programmable flexibility for future switching fabrics. Multicasting can be performed in an IP layer to allow a single source to simultaneously transmit packets to multiple destinations. However, by migrating this functionality lower in the network stack to the optical layer, broadband packet-based applications can be implemented to be supported directly on the underlying optical network, with reduced effective cost.

An example demonstrates an embodiment of a CLB 200 performing multicasting. In this embodiment, wavelength-striped optical messages can be transmitted from a single source to a subset of the destination ports. The distributed electronic routing logic control of the optical switching fabric can support the multiwavelength packet multicast operation.

The example herein includes a packet-splitter-and-delivery (PSaD) architecture. The input wavelength-striped packet can be split multiple ways to enable multicasting. The example herein includes an optical switching fabric that is internally composed of M parallel optical packet switches interconnecting N network terminals. FIG. 4 discussed herein above shows the wavelength-striped optical packet structure. Two parallel optical packet switches are utilized to connect four distinct fabric ports. The PSaD architecture allows for M distinct and independent paths between each source and destination, in a non-blocking fashion. Each path (i.e. optical switch) supports the multiwavelength optical packet format. The optical switching fabric can be configured to unicast using a single switch, or can be configured to multicast using combinations of several of the switches.

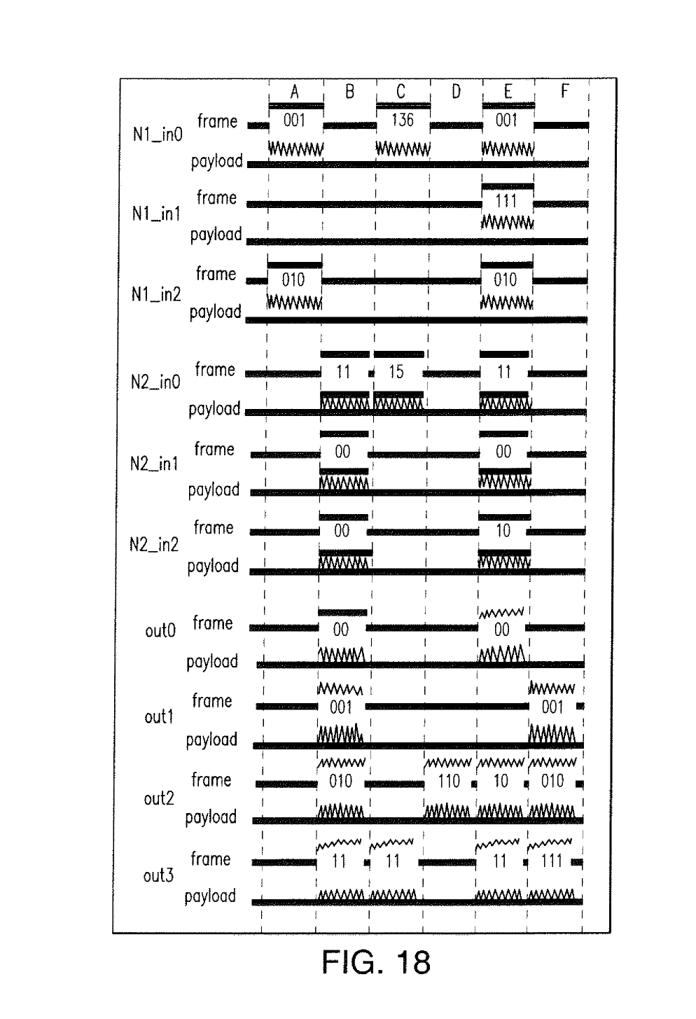

To perform the packet multicasting, a pattern of 8×10-Gb/s wavelength-striped optical messages are generated and injected in the fabric. The packets are routed through both parallel switches and are multicasted to two different destinations (if desired) by unicasting on each switch. FIG. 18 shows the waveform traces associated with the optical packet traffic sequence, and the resulting packets egressing from the switching fabric.

The 8×10-Gb/s multiwavelength optical messages are routed through the complete switching fabric, and emerge at the destinations that are encoded in the control address headers. Thus, the packets are routed from one input port to multiple output ports. The switching fabric of the example provides both unicasting using a single switch entity and multicasting with both switches. BER measurements show that all packets are received error-free, that is having BERs less than 10⁻¹² on all eight payload wavelengths.

### Example 3

According to another aspect of the disclosed subject matter, network routing algorithms can possess an improved awareness of the properties of optical signals as the packets propagate on the physical layer. The improved awareness can be achieved by embedding fast packet-scale performance monitoring within the optical network layer. Optical performance monitoring can provide networks and systems to monitor and isolate physical-layer impairments, and to perform a fast evaluation of the quality of the transmitted data signals. These metrics can then provide feedback to higher network layers or a control plane to improve routing. Performance monitoring within OPS fabrics can allow a network to isolate degradations and reroute optical messages accounting for impairments.

In the network, packet-level monitoring of the optical-signal-to-noise ratio (OSNR) of the optical packet can be performed. An OSNR monitor can include a ¼-bit Mach-Zehnder delay-line interferometer, which can support multiple modulation formats and is resistant to the effects of other impairments, such as chromatic dispersion and polarization mode dispersion. Using power monitors and a high-speed FPGA, the OSNR can be evaluated on a message timescale. The packet-level OSNR monitor can then trigger the rerouting of degraded packets designated as high-priority.

The disclosed subject matter includes a cross-layer network node that utilizes enhanced physical-layer awareness and knowledge of higher-layer parameters to allow packet-scale reactive switching. The CLB can utilize distributed control plane management and cross-layer capabilities given by packet-level monitoring to enable multilayer traffic engineering and fast optical switching.

In the example further describing the design and demonstration of an exemplary embodiment of the node, subsystems are implemented, including a high-capacity optical switching fabric, a TiSER performance monitor, and a FPGA control plane. Fast packet-scale reconfiguration of the switching fabric, supporting the error-free transmission of 8×40-Gb/s multiwavelength optical packets and the distortion-less transmission of 10GE-based video traffic using an O-NIC are demonstrated. Cross-layer interactions between the application and physical layers are further shown by varying the effective bit rate of the video data depending on link quality.

The disclosed subject matter herein can be utilized in networks to incorporate packet-level measurement techniques, schemes for monitoring the health of optical channels, and performance prediction in next-generation multi-terabit networks.

The foregoing merely illustrates the principles of the disclosed subject matter. Various modifications and alterations to the described embodiments will be apparent to those skilled in the art in view of the teachings herein. It will be appreciated that those skilled in the art will be able to devise numerous modifications which, although not explicitly described herein, embody its principles and are thus within its spirit and scope.

1. An optical network for routing an optical message from at least one source to at least two of a plurality of destination ports comprising:
at least one input port to receive the optical message;
two or more output ports, each configured to communicate with at least one corresponding destination port of the plurality of destination ports; and
a plurality of photonic switching nodes coupling the at least one input port with the at least two output ports and configured to route the optical message from the at least one input port to the at least two destination ports.

2. The optical network of claim 1, wherein the at least two of the plurality of destination ports comprises less than all of the plurality of destination ports.

3. The optical network of claim 1, wherein the optical message comprises routing information at a first wavelength and data at a second wavelength, the plurality of photonic switching nodes being configured to route the optical message based on the routing information.

4. The optical network of claim 1, further comprising at least one splitter to distribute the optical message to one or more of the plurality of photonic switching nodes.

5. The optical network of claim 1, wherein the number of photonic switching nodes is M, and the plurality of photonic switching nodes are configured to provide M paths between the at least one source and each one of the plurality of destination ports.

6. The optical network of claim 5, wherein the M paths are non-blocking paths.

7. The optical network of claim 1, wherein the plurality of photonic switching nodes are configured to route the optical message to the at least two destination ports substantially simultaneously.

8. The optical network of claim 1, wherein the plurality of photonic switching nodes comprise a programmable logic device.

9. A method for transmitting an optical message through an optical network comprising:
receiving the optical message from at least one source;
routing the optical message from the at least one source to at least two of a plurality of destination ports.

10. The method of claim 9, wherein routing the optical message further comprises routing the optical message to less than all of the plurality of destination ports

11. The method of claim 9, wherein the optical message comprises routing information at a first wavelength and data at a second wavelength, and routing the optical message farther comprises routing the optical message based on the routing information.

12. The method of claim 9, wherein routing the optical message further comprises routing the optical message to the at least two of the plurality of destination ports substantially simultaneously.

13. An optical network comprising:
a monitor to measure an attribute of the optical message;
a photonic switching node, coupled to the monitor and receiving the measured attribute therefrom, and configured to route the optical message between a source and a destination port based on the measured attribute of the optical message.

14. The optical network of claim 13, wherein the attribute is related to a quality of the optical message.

15. The optical network of claim 13, wherein the attribute is an optical-signal-to-noise ratio of the optical message.

16. The optical network of claim 13, wherein the monitor comprises a delay-line interferometer.

17. The optical network of claim 13, wherein the monitor comprises a power monitor.

18. The optical network of claim 17, wherein the monitor comprises a programmable logic device coupled to the power monitor.

19. A method for transmitting a optical message through an optical network comprising:
measuring an attribute of the optical message; and
routing the optical message between a source and a destination port based on the measured attribute of the optical message.

20. The method of claim 19, wherein measuring the attribute further comprises measuring the attribute related to a quality of the optical message.

21. The method of claim 19, wherein measuring the attribute further comprises measuring an optical-signal-to-noise ratio of the optical message.

22. An optical network comprising:
a sensor to sample at least one of a plurality of optical messages; and
a processor, coupled to the sensor and receiving the sample therefrom, and configured to derive at least one eye diagram corresponding to the at least one of the plurality of optical messages.

23. The optical network of claim 22, wherein the sensor comprises a TiSER oscilloscope.

24. The optical network of claim 22, wherein the processor is further configured to determine a quality factor of the at least one of the plurality of optical messages from the at least one eye diagram.

25. The optical network of claim 22, wherein the processor is further configured to provide an indication of a performance of the optical network based on a bit-error rate.

26. A method of evaluating optical messages in an optical network:
sampling at least one of a plurality of optical messages;
deriving at least one eye diagram corresponding to the at least one sampled optical messages.

27. The method of claim 26, further comprising determining a quality factor of the at least one of the plurality of optical messages from the at least one eye diagram.

28. The method of claim 27, wherein the quality factor is a bit-error rate of the at least one of the plurality of optical messages, and the method further comprises providing an indication of a performance of the optical network based on the bit-error rate.
